(19) United States
(12) Patent Application Publication
(10) Pub. No.: US 2007/0160721 A1
(43) Pub. Date: Jul. 12, 2007

(54) SYSTEM AND METHOD FOR AUDITING HAZARDOUS SUBSTANCES OF A PRODUCT

(75) Inventors: CHUNG-I LEE, Tu-Cheng (TW); HAI-HONG LIN, Shenzhen (CN); GUO-LING OU-YANG, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/552,982

(22) Filed: Oct. 26, 2006

(30) Foreign Application Priority Data
Jan. 12, 2006 (CN) 200610032912.2

(51) Int. Cl. A23L 1/27

(52) U.S. Cl. 426/250

(57) ABSTRACT

A system for auditing hazardous substances of a product includes: a receiving module (200) configured for receiving a product composition analysis provided by a supplier; an auditing module (202) configured for analyzing maximum concentrations of the hazardous substances in each homogeneous materials and components in the product composition analysis by weight of the homogeneous materials, and determining whether the maximum concentration of each hazardous substance in each homogeneous materials and components in the product complies with RoHS specifications; and an informing module (206) configured for informing the supplier or a purchaser of the auditing result. A related method is also disclosed.

### BACKGROUND OF THE INVENTION

1. Field of the Invention

The present invention relates to a system and method for auditing hazardous substances of a product.

2. General Background of the Invention

The restriction of hazardous substances in electrical and electronic equipment (RoHS) directive (2002/95/EC), as the name suggests, aims at the restriction of the use of certain hazardous substances in electrical and electronic equipment.

RoHS is often referred to as the “lead-free” directive, but it restricts the use of the following 6 substances: lead, mercury, cadmium, chromium VI (also know as hexvavlent chromium or Cr6⁺), polybrominated biphenyl (PBB), polybrominated diphenyl ether (PBDE). PBB and PBDE are flame-retardants used in some plastics.

The maximum concentrations of the hazardous substances in each homogeneous composition is 0.1% (except for Cadmium which is limited to 0.01%) by weight of the homogeneous composition. This means that the limits do not apply to the weight of the finished product, or even to a component, but to any single substance that could (theoretically) be separated mechanically—for example, the sheath on a cable or the tinning on a component lead.

Some examples are, a radio comprising a case, screws, washers, a circuit board, speakers, etc; the circuit board comprising a bare PCB, ICs, resistors, switches etc; the switch comprising a case, a lever, a spring, contacts, pins, etc. The contact might comprise a copper strip with a surface coating.

Therefore, any products distributed into the market must comply with the RoHS. Thus, before buying a product or a piece of composition, buyers are usually given the duty of checking if the product or the composition complies with the RoHS. Generally, the buyer asks suppliers for a RoHS test result of the product. It is only when the RoHS test result shows that the product complies with the RoHS, which the buyer will decide to purchase the product. However, buyers in manufacturing enterprises generally are assigned the duty of purchasing a large quantity of products or compositions everyday, making it relatively hard and difficult to manage the RoHS test results of the products or compositions through manual work.

What is required, therefore, is a system and method for auditing hazardous substances of a product regularly and efficiently.

### SUMMARY

A system for auditing hazardous substances of a product includes: a receiving module configured for receiving products composition analyses uploaded corresponding to each product provided by suppliers; an auditing module configured for analyzing maximum concentrations of the hazardous substances in each homogeneous materials and components in the product composition analysis by weight of the homogeneous materials, and determining whether the maximum concentration of each hazardous substance in each homogeneous materials and components in the product complies with RoHS specifications; and an informing module configured for informing the supplier or a purchaser of an auditing result.

A computer-based method for auditing hazardous substances of a product includes the steps of: receiving products composition analyses corresponding to each product provided by suppliers; analyzing maximum concentrations of the hazardous substances in each homogeneous materials and components in the product composition analysis by weight of the homogeneous materials, and determining whether the maximum concentration of each hazardous substance in each homogeneous materials and components in the product complies with RoHS specifications; informing a purchaser of buying the product if the maximum concentrations of the hazardous substances in each homogeneous materials and components in the product composition analysis comply with the RoHS specifications; sending an auditing result to the supplier if the maximum concentration of any hazardous substance in each homogeneous materials and components in the product composition analysis does not comply with the RoHS specifications.

Other advantages and novel features of the present invention will become more apparent from the following detailed description of preferred embodiments when taken in conjunction with the accompanying drawings.

### BRIEF DESCRIPTION OF THE DRAWINGS

FIG. 1 is a schematic diagram of hardware configuration of a system for auditing hazardous substances of a product in accordance with one preferred embodiment;

FIG. 2 is a schematic diagram of function modules of the website of FIG. 1; and

FIG. 3 is a flowchart of a preferred method for auditing hazardous substances of a product in accordance with a preferred embodiment.

### DETAILED DESCRIPTION OF THE INVENTION

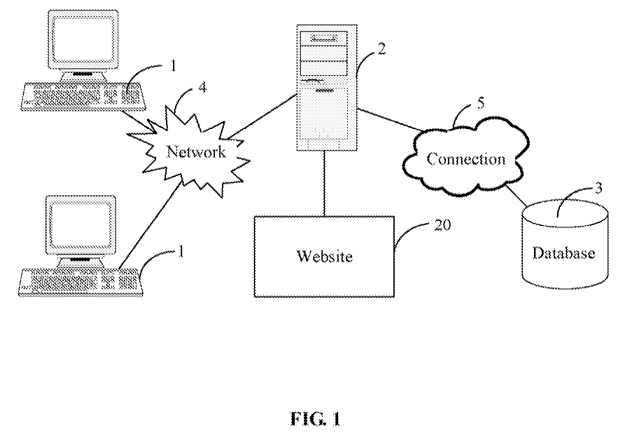

FIG. 1 is a schematic diagram of hardware configuration of a system for auditing hazardous substances of a product in accordance with one preferred embodiment. The system typically includes a plurality of distributed client computers 1 (only two shown), an application server 2, and a database 3. The client computers 1 connect with the application server 2 via a network 4, and the application server 2 connects to the database 3 through a connection 5.

Each client computer 1 can be a personal computer (PC) that may include a plurality of hardware devices, such as a central processing unit (CPU), a memory, a hard-disk, a monitor, a mouse, and a keyboard (not shown). The client computers 1 may also be installed with software, such as an operating system (OS) and software applications. Through these hardware and software resources, the client computers 1 further provide a graphical user interface (GUI) for users to operate the client computers 1. The users may be suppliers that provide products, or buyers/purchasers or any related employees of an enterprise involved in trading products.

The application server 2 may also be the PC similar to the client computer 1, or may be a network server computer that can process more data with a faster computing speed than a typical PC. In the preferred embodiment, the application server 2 hosts a website 20 accessible by both the suppliers and the purchasers through the client computer 1 in order to audit the products provided by the suppliers to check for RoHS compliance. Furthermore, the website 20 is connected to the database 3 via the connection 5 for information and data exchanges. The connection 5 may be an open database connectivity (ODBC), or a java database connectivity (JDBC).

The network 4 may be an electronic network based on a transfer control protocol and Internet protocol (TCP/IP), such as a local area network (LAN) or the Internet.

The database 3 is mainly configured (i.e. structured and arranged) for storing RoHS specifications and any other data relating to the RoHS compliance auditing, such as product composition analysis of the products.

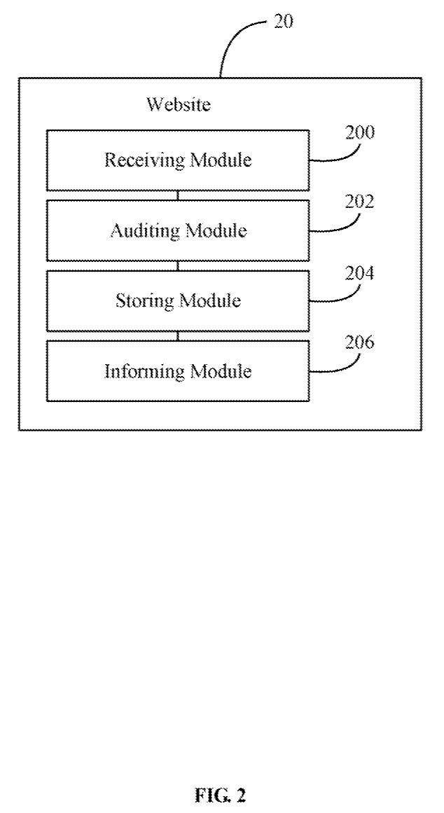

FIG. 2 is a schematic diagram of function modules of the website 20. The website 20 mainly includes a receiving module 200, an auditing module 202, a storing module 204, and an informing module 206.

The receiving module 200 is configured for receiving products composition analyses uploaded corresponding to each product provided by the suppliers via the client computer 1. The website 20 typically provides a supplier list that lists a plurality of suppliers, and a product list that lists products that are provided by the suppliers in the supplier list. If a purchaser wants to buy the products, the purchaser may use the client computer 1 to access the website 20. The purchaser selects a combination of selected products and the suppliers from the product list and the supplier list correspondingly.

The auditing module 202 is configured for determining whether the products composition analyses received by the receiving module 200 are required by the purchaser. The auditing module 202 is further configured for analyzing maximum concentrations of the hazardous substances in each homogeneous material and components in the product composition analysis of the selected products by weight of the homogeneous materials. This means that the limits do not apply to the weight of the finished product, or even to a component, but to any single substance that could (theoretically) be separated mechanically. The homogeneous material in RoHS terms means a component or material that cannot be mechanically disjointed into different materials by unscrewing, cutting, crushing, grinding, abrasive processes and similar procedures. RoHS specifications require a maximum concentration value of up to 0.1% by weight in homogenous materials for lead, mercury, hexavalent chromium, PBB and PBDE, and a maximum value of 0.01% by weight in homogenous materials for cadmium. Homogeneous is defined as “of uniform composition throughout”. This means that a semiconductor may not be classified as homogeneous, as it is composed of different homogeneous elements such as lead, silicon, gold, frames, wires, etc. which must individually comply with the requirements of the RoHS Directive. Some examples are, a radio comprising a case, screws, washers, a circuit board, speakers, etc; the circuit board comprising a bare PCB, ICs, resistors, switches etc; the switch comprising a case, a lever, a spring, contacts, pins, etc. The contact might comprise a copper strip with a surface coating.

The selected product passes the auditing if the maximum concentrations of the hazardous substances in each homogeneous material and components in the product composition analysis of the selected products by weight of the homogeneous materials comply with the RoHS specifications.

The storing module 204 is configured for storing information of the product into the database 3 according to a supplier name, a product name, and types of the compositions of the product, if the product composition analysis is required by the purchaser.

The informing module 206 is configured for sending an auditing result to the supplier if the maximum concentration of any hazardous substance in each homogeneous material and components in the selected product does not comply with the RoHS specifications; and informing the purchaser of purchasing the product if the maximum concentrations of the hazardous substances in each homogeneous material and components in the selected product comply with the RoHS specifications.

The auditing module 202 is further configured for searching the database 3 to detect whether a composition analysis of the selected product uploaded by the supplier is consistent with the product information stored in the database 3, i.e., if the supplier uploads the product composition analysis of the product that has already been audited. If the product composition analysis information is consistent with the production information stored in the database 3, the auditing module 202 does not audit the product composition analysis uploaded by the supplier.

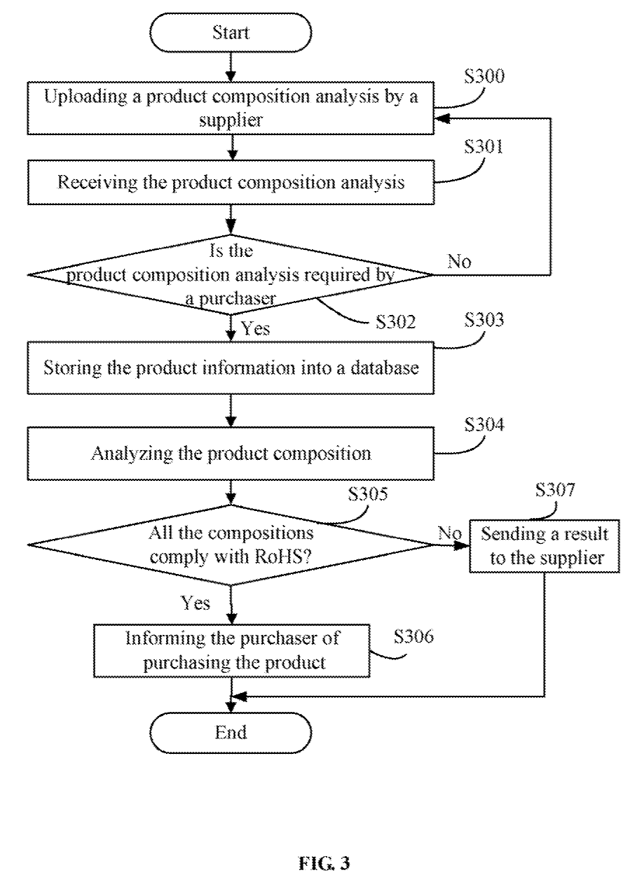

FIG. 3 is a flowchart of a method for auditing hazardous substances of a product in accordance with a preferred embodiment. In step S300, through the client computer 1, the suppliers upload the products composition analyses into the website 20. In step S301, the receiving module 200 receives the products composition analyses uploaded corresponding to each product provided by the suppliers.

In step S302, the auditing module 202 determines whether the product composition analysis received by the receiving module 200 is required by the purchaser. If the purchaser does not require the product composition analysis, the procedure returns to step S300.

If the product composition analysis is required by the purchaser, in step S303, the storing module 204 stores information of the product into the database 3 according to the supplier name, the product name, and the types of the compositions in the product.

In step S304, the auditing module 202 analyzes the maximum concentration of the hazardous substance in each homogeneous material and components in the product composition analysis of the selected products by weight of the homogeneous materials. This means that the limits do not apply to the weight of the finished product, or even to a component, but to any single substance that could (theoretically) be separated mechanically. The homogeneous material in RoHS terms means a component or material that cannot be mechanically disjointed into different materials by unscrewing, cutting, crushing, grinding, abrasive processes and similar procedures. RoHS specifications require a maximum concentration value of up to 0.1% by weight in homogenous materials for lead, mercury, hexavalent chromium, PBB and PBDE, and a maximum value of 0.01% by weight in homogenous materials for cadmium. Homogeneous is defined as “of uniform composition throughout”. This means that a semiconductor may not be classified as homogeneous, as it is composed of different homogeneous elements such as lead, silicon, gold, frames, wires, etc. which must individually comply with the requirements of the RoHS Directive. Some examples are, a radio comprising a case, screws, washers, a circuit board, speakers, etc; the circuit board comprising a bare PCB, ICs, resistors, switches etc; the switch comprising a case, a lever, a spring, contacts, pins, etc. The contact might comprise a copper strip with a surface coating.

In step S305, the auditing module 202 reads the RoHS specifications stored in the database 3, and determines whether the maximum concentrations of the hazardous substances in each homogeneous material and components in the product composition analysis of the selected products by weight of the homogeneous materials comply with the RoHS specifications.

If the maximum concentration of any hazardous substance in each homogeneous material and components of the selected product does not comply with the RoHS specifications, in step S307, the informing module 206 sends the auditing result to the supplier denoting that the product does not pass the auditing, whereupon the procedure ends.

If the maximum concentrations of the hazardous substances in each homogeneous material and components in the selected product comply with the RoHS specifications, in step S306, the informing module 206 sends the auditing result to the supplier and the purchaser, and informs the purchaser of purchasing the product.

In step S303, the auditing module 202 searches the database 3 to detect whether a composition analysis of the selected product uploaded by the supplier is consistent with the product information stored in the database 3, i.e., if the supplier uploads the product composition analysis of the product that has already been audited. If the product composition analysis information is consistent with the production information stored in the database 3, the auditing module 202 does not audit the product composition analysis uploaded by the supplier.

It is to be understood that other embodiments may be utilized and structural changes may be made without departing from the scope of the present invention.

What is claimed is:

1. A system for auditing hazardous substances of a product, the system comprising:
a receiving module configured for receiving products composition analyses uploaded corresponding to each product provided by suppliers;
an auditing module configured for analyzing maximum concentrations of the hazardous substances in each homogeneous materials and components in the product composition analysis by weight of the homogeneous materials, and determining whether the maximum concentration of each hazardous substance in each homogeneous materials and components in the product complies with RoHS specifications; and
an informing module configured for informing the supplier or a purchaser of an auditing result.

2. The system of claim 1, wherein the auditing module is further configured for determining whether the product composition analysis received by the receiving module is required by the purchaser.

3. The system of claim 2, further comprising a storing module configured for storing information of the product into a database according to a supplier name, a product name, types of the compositions in the product, if the product composition analysis is required by the purchaser.

4. The system of claim 3, wherein the RoHS specifications is stored in the database.

5. A computer-based method for auditing hazardous substances of a product, the method comprising the steps of:
receiving products composition analyses corresponding to each product provided by suppliers;
analyzing maximum concentrations of the hazardous substances in each homogeneous materials and components in the product composition analysis by weight of the homogeneous materials, and determining whether the maximum concentration of each hazardous substance in each homogeneous materials and components in the product complies with RoHS specifications;
informing a purchaser of buying the product if the maximum concentrations of the hazardous substances in each homogeneous materials and components in the product composition analysis comply with the RoHS specifications;
sending an auditing result to the supplier if the maximum concentration of any hazardous substance in each homogeneous materials and components in the product composition analysis does not comply with the RoHS specifications.

6. The method of claim 5, further comprising the steps of:
uploading the products composition analyses to a website by the suppliers.

7. The method of claim 6, further comprising the steps of:
determining whether the product composition analysis received is required by the purchaser;
storing information of the product into a database according to a supplier name, a product name, types of the compositions in the product, if the product composition analysis is required by the purchaser;
returning to the uploading step, if the product composition analysis is required by the purchaser.
